(19) United States
(12) Patent Application Publication
(10) Pub. No.: US 2013/0213157 A1
(43) Pub. Date: Aug. 22, 2013

(54) Transfer Case

(71) Applicants: Duane Martin, New Holland, PA (US); Anthony M. Hostetter, Mohnton, PA (US)

(72) Inventors: Duane Martin, New Holland, PA (US); Anthony M. Hostetter, Mohnton, PA (US)

(21) Appl. No.: 13/398,055

(22) Filed: Feb. 16, 2012

(51) Int. Cl. F16H 37/06

(52) U.S. Cl. 74/15.82

(57) ABSTRACT

A transfer case for a power take off assembly is provided. The transfer case includes a front housing and a rear housing. The front housing includes a main shaft receiving passageway for receiving a main shaft connecting to the transmission, a front drive shaft receiving passageway for receiving a front drive assembly, and a first PTO shaft receiving passageway. The first PTO shaft receiving passageway is positioned between the main shaft receiving passageway and the front drive shaft receiving passageway. Furthermore, the first PTO shaft receiving passageway includes a first PTO shaft control assembly for receiving the PTO shaft. The rear housing includes a second PTO shaft receiving passageway with a second PTO shaft control assembly for receiving the PTO shaft and positioned to correspond with first PTO shaft receiving passageway.

### FIELD OF THE INVENTION

The invention relates to a transfer case and, more particularly, to a transfer case that accommodates a power take off shaft there through.

### BACKGROUND

A transfer case is a housing unit, part of a vehicle's drive system, and more particularly found in four wheel drive and all wheel drive vehicles. The transfer case connects to a vehicle transmission and also to the front and rear axles by means of drive shafts. The transfer case receives power from the transmission and sends it to both the front and rear axles through the drive shafts. Power is generally transferred from the transmission to the transfer case using a set of gears or a chain. As a result, the transfer case is generally positioned behind the transmission.

On some vehicles, including commercial trucks and tractors, a power take off (PTO) is provided to transfer engine power to another piece of equipment. The power take off transfers engine power from the transmission to a secondary implement. Generally, the power take off mechanism is connected to the transmission providing power to an attachment or separate machine through a connected drive shaft.

In some cases, if the transmission is manual, then the power take off may be positioned lower or under the transmission. However, this creates clearance problems, as the power take off mechanism and drive shaft are routed under the transfer case. Furthermore, it is difficult to maintain acceptable driveline angles. In an automatic transmission, the power take off mechanism is commonly positioned on one side of the transmission. As a result, the power take off assembly generally includes a plurality of shafts and universal joints to route the power take off assembly around the transfer case as shown by dashed lines in FIG. 2. This design proves difficult when attempting to maximize ground clearance of the vehicle and minimize the number of and angles through which u-joints connect the power take-off or power takeoff (PTO) shafts.

### SUMMARY

It is therefore an object of the invention, among other objects, to provide a transfer case having a power take off drive shaft running there through.

A transmission transfers power to the transfer case which has been adapted to receive a power take off shaft that powers a secondary implement positioned behind the transmission. The transfer case includes a front housing and a rear housing. The front housing includes a main shaft receiving passageway for receiving a main shaft connecting to the transmission, a front drive shaft receiving passageway for receiving a front drive assembly, and a first PTO shaft receiving passageway. The first PTO shaft receiving passageway is positioned between the main shaft receiving passageway and the front drive shaft receiving passageway. Furthermore, the first PTO shaft receiving passageway includes a first PTO shaft control assembly for receiving the PTO shaft. The rear housing includes a second PTO shaft receiving passageway with a second PTO shaft control assembly for receiving the PTO shaft and positioned to correspond with first PTO shaft receiving passageway.

### BRIEF DESCRIPTION OF THE DRAWINGS

The invention will be explained in detail with reference to embodiments, referring to the appended drawings, in which:

FIG. 1 is a perspective view of a transfer case according to the invention assembled with a transmission and a power take off assembly;

FIG. 2 is a side view of the transfer case according to the invention showing different positions of the power take off assembly before and after the power take off assembly passes through transfer case;

FIG. 3 is a perspective view of a front housing member of the transfer case according to the invention;

FIG. 4 is a perspective view of a rear housing member of transfer case according to the invention;

FIG. 5 is a sectional view of the transfer case shown in FIG. 1 taken along line 5-5;

FIG. 6 is an exploded rear perspective view of the transfer case showing a rear bearing assembly and the a power take off shaft passing there through;

FIG. 7 is a sectional view of the transfer case shown in FIG. 2 taken along line 7-7;

FIG. 8 is a rear perspective view of the transfer case showing an adapter for a secondary implement;

FIG. 9 is a perspective view of another transfer case according to the invention; and

FIG. 10 is a sectional view of the transfer case shown in FIG. 9 taken along line 10-10.

### DETAILED DESCRIPTION OF THE DRAWINGS

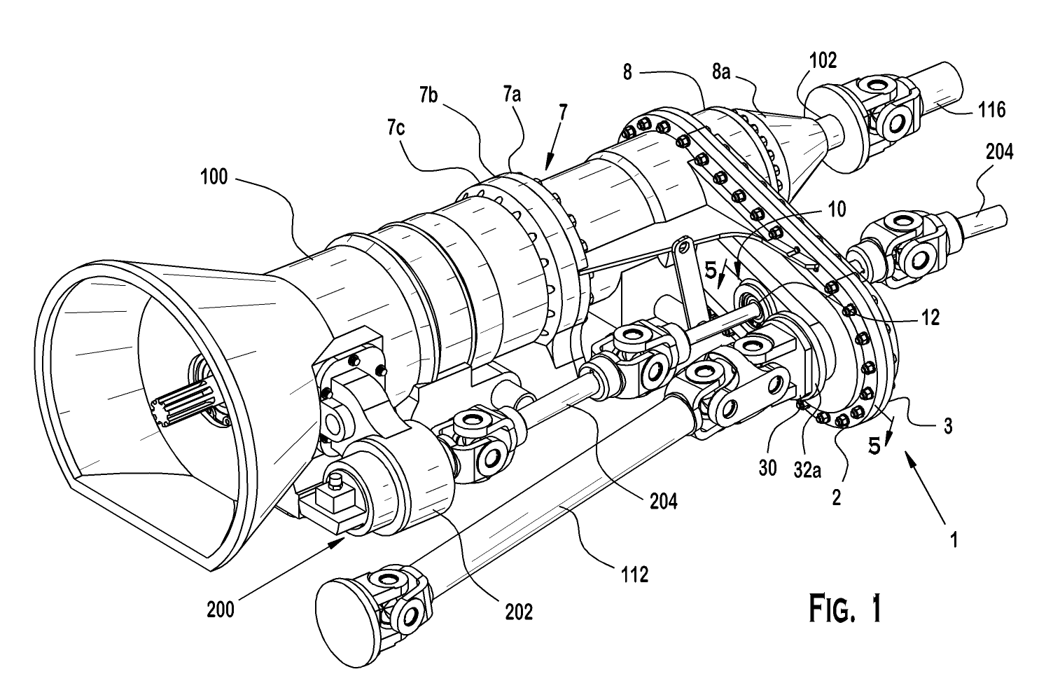

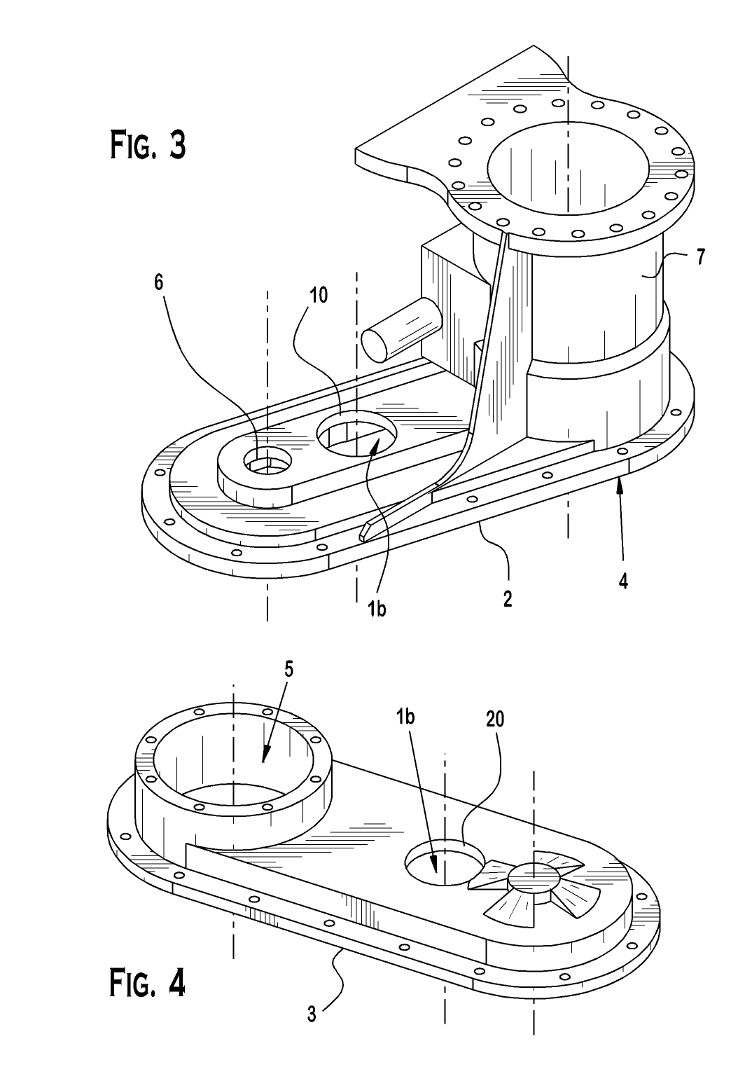

The invention will now be described in detail with reference to the FIGS. 1-10.

With reference to FIGS. 1 through 7, a transfer case 1 according to the invention is shown. The transfer case 1 is adapted to receive a power take off (PTO) shaft 204 and power a front drive shaft 112 and a rear drive shaft 116 through a main shaft 102 that connects to an output shaft (not shown) of a transmission 100. The transfer case 1 includes a housing having a front housing 2 and a rear housing 3, a front main shaft receiving passageway 4, a rear main shaft receiving passageway 5, a front drive shaft receiving passageway 6, a first PTO shaft receiving passageway 10 with a first PTO shaft control assembly 12, and a second PTO shaft receiving passageway 20 with a second PTO shaft control assembly 22. by a main shaft 102 that connects to an output shaft (not shown) of

In the embodiment shown, the front housing 2 and rear housing 3 are metal and include a plurality of openings that together define drive shaft passageways. Each of the front main shaft receiving passageway 4, the rear main shaft receiving passageway 5, the front drive shaft receiving passageway 6, the first PTO shaft receiving passageway 10, and the second PTO shaft receiving passageway 20 is a through hole extending from the front housing 2 to the rear housing 3. In the embodiment shown, the first PTO shaft receiving passageway 10 is located between the front main shaft receiving passageway 4 and the front drive shaft receiving passageway 6. The front housing 2 and the rear housing 3 may be cast from molten metal in a mold or machine tooled at a secondary production step.

The front housing 2 complements the rear housing 3 and vice versa. Certain through holes positioned on the front housing 2 correspond with matching through holes in the rear housing 3. Furthermore, peripheral outer walls of the front housing 2 and the rear housing 3 have similar contours, so that the front housing 2 compliments the rear housing 3 in a fitted connection.

The front housing 2 and the rear housing 3 define a cavity 1b that holds internal components of the transfer case 1, including a drive chain 40 and sprockets. Each of the front and rear housings 2, 3 include a complementary flange sections disposed on the outer periphery wall. In the embodiment shown, a seal (i.e. an anaerobic compound) or gasket is positioned between the two flanges which are secured to each other by fasteners, such as a plurality of nuts and bolts or threaded fasteners in corresponding threaded fastener receiving openings. Depending on the fasteners used, the one or both of the flanges may include fastener receiving passageways or threaded fastener receiving spaces. However, other known ways to secure and seal the front housing 2 with the rear housing 3 are possible, including welding or forming a monolithic transfer case 1 housing from casting.

As shown in FIGS. 1-4, the front housing 2 includes a transmission connection piece 7, the front main shaft receiving passageway 4, the front drive shaft receiving passageway 6, and the first PTO shaft receiving passageway 10 disposed along the front housing outer wall .

The transmission connection piece 7 is positioned at an end of the front housing 2 and proximate the passageway 4. In the embodiment shown, the connection piece 7 includes a flange 7a that connects to the transmission 100 using fasteners 7c (i.e. nuts, bolts, or other known fasteners) and a seal 7b positioned there between. The connection piece 7 is a tubular element with a hollow cavity sized such that an main shaft 102 of the transfer case 1 fits there through. In the embodiment shown, the front housing 2 attaches to the transmission 100, however, the front housing 2 may be cast with the transmission 100. In the embodiment shown, the main shaft 102 connects to the output shaft (not shown) of the transmission 10 between the front main shaft receiving passageway 4 and a connection piece 7, which is positioned opposite the front main shaft receiving passageway 4 and connects to the transmission 100. Again, it is also possible that the front housing 2, the front main shaft receiving passageway 4 are cast with the transmission 100, as a monolithic integral construction.

In the embodiment shown, the output shaft (not shown) of the transmission turns in one sealed environment, while the main shaft 102 of the transfer 1 case turns inside another sealed environment.

The front main shaft receiving passageway 4 is tubular, and opens toward the transmission 100 with the connection piece 7 positioned on an end of the front main shaft receiving passageway 4. The connection piece 7 includes flange 7a that corresponds with an end of and connects with the transmission 100. The front main shaft receiving passageway 4 and connection piece 7 structure leads into a cavity 1b of the transfer case 1, which is provided when the front housing 2 is assembled with the rear housing 3.

The front drive shaft receiving passageway 6 is positioned at another end of the front housing 2, opposite the front main shaft receiving passageway 4. The front drive shaft receiving passageway 6 extends into the same cavity 1b and is sized to accommodate a front drive assembly 30, which is described in detail below.

The first PTO shaft receiving passageway 10 is positioned between the front main shaft receiving passageway 4 and the front drive shaft receiving passageway 6. The first PTO shaft receiving passageway 10 is sized to accommodate the PTO shaft 204 and the first PTO shaft control assembly 12. In the embodiment shown, the first PTO shaft receiving passageway 10 is positioned closer to the front drive shaft receiving passageway 6 than the front main shaft receiving passageway 4. However, the first PTO shaft receiving passageway 10 may be alternatively positioned but should be positioned such that the received power take off shaft 204 does not interfere with the front drive assembly 30 positioned through the front drive shaft receiving passageway 6 and in cavity 1b, the front drive shaft 112, and other transfer case internal components, such as the drive chain 40.

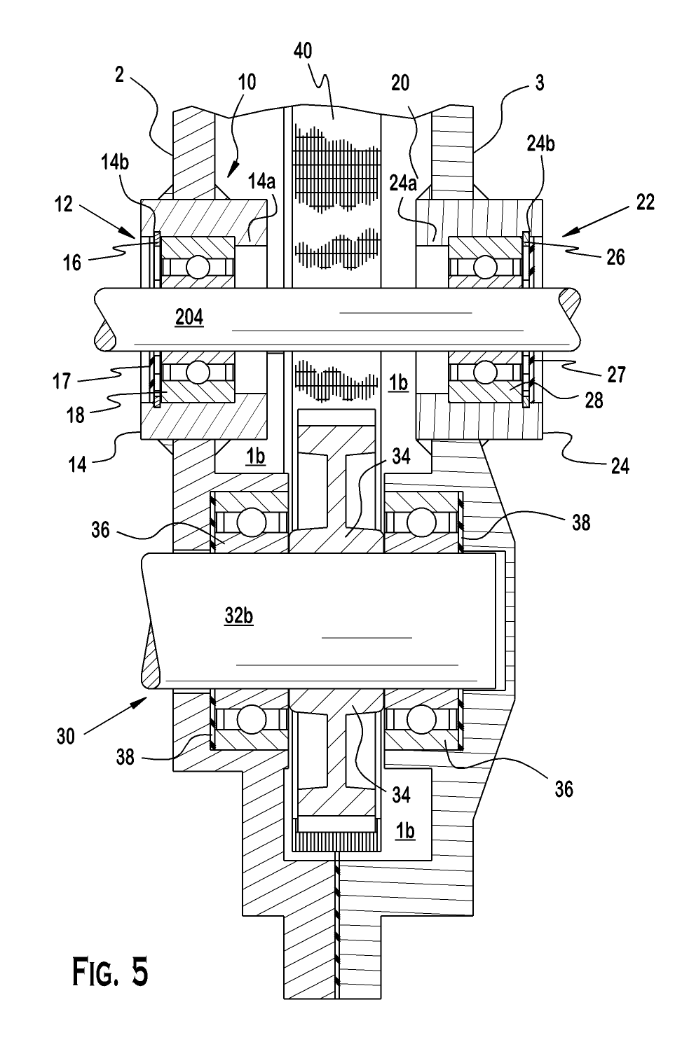

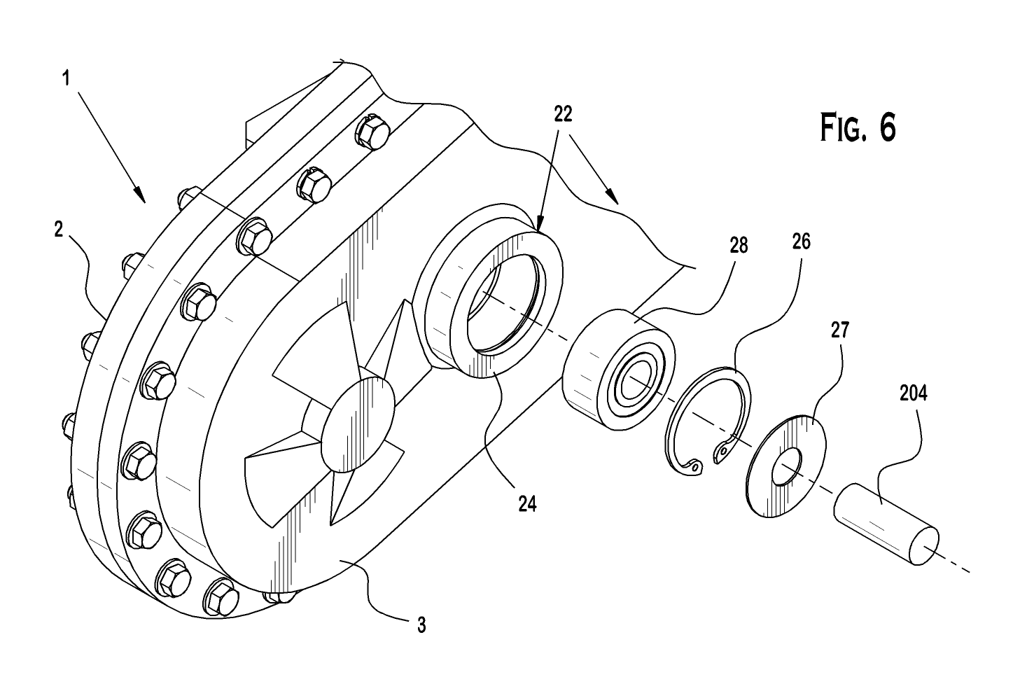

As shown in FIG. 5, the first PTO shaft control assembly 12 includes, a front collar 14, a bearing 18, a seal member 17, and a retainer 16.

The front collar 14 is a tubular element that is positioned in the first PTO shaft receiving passageway 10 and is cast with or secured to the outer wall of the front housing 2 by a weld or other securing means known to the art. One end of the front collar 14 (front end) extends through the first PTO shaft receiving passageway 10 and beyond the outer wall of the front housing 2.

The front collar 14 is generally tubular having an internal diameter and an outer diameter that correspond with the inner collar surface and the outer collar surface respectively. The front collar 14 can either be cast with the front housing 2 or a separate component that is secured to the front housing 2 along the first PTO shaft receiving passageway 10. The internal diameter of the front collar 14 is sized to accommodate components of the first PTO shaft control assembly 12 and the PTO shaft 204, while the outer diameter of the front collar 14 is sized to snugly fit with the first PTO shaft receiving passageway 10, if the front collar 14 is a separate component to the front housing 2. In the embodiment shown, the front collar 14 thickness is defined by a distance from the inner collar surface to the outer collar surface which is sized so that the front collar 14 supports the outer wall of the front housing 2 around the first PTO shaft receiving passageway 10, such that the outer wall of the front housing 2 does not degrade when the transfer case 1 operates with a power take off shaft 204 positioned therethrough.

Further shown in FIG. 5, the front collar 14 includes a stop 14a and a retainer receiving passageway 14b . The stop 14a is a wall positioned on another end of the front collar 14 (rear end) and includes a through hole sized to accommodate the PTO shaft 204 therethrough. The retainer receiving passageway 14b is located at a distance from the stop 14a toward the secured end. The retainer receiving passageway 14b is disposed along the internal collar surface of the front collar 14. In the embodiment shown, the retainer receiving passageway 14b is a channel extending from the internal collar surface into front collar 14 and toward the outer collar surface. The depth and dimensions of the channel depends on the type of retainer 16 used for securing the bearing 18 in the front collar 14. Also, the distance between the stop 14a and the retainer receiving passageway 14b is dependent on dimensions of the the bearing 18, which are positioned there between when the first PTO shaft control assembly 12 is assembled in the first PTO shaft receiving passageway 10. In the embodiment shown, the retainer receiving passageway 14b is circularly positioned around the internal collar surface such that the retainer receiving passageway 14b is keyed with the retainer 16 when assembled.

The bearing 18 is positioned between the fixed, non rotating front collar 14 and the rotating power take off shaft 204, in which the rotating part (inner ring) and the stationary part (outer ring) are separated by a ring of rolling elements in order to reduce friction.

In the embodiment shown, the bearing 18 is known as a rolling element bearing, and in particular, a ball bearing. The bearing 18 permits constrained relative motion between front collar 14 and the PTO shaft 204, while also reducing friction. Alternatively, the bearing may be a cylindrical roller, needle, tapered roller, or spherical roller type of bearing. However, in other embodiments, the bearing 18 can be a plain bearing or a friction bearing having just a bearing surface and no rolling elements. The bearing 18 includes an external diameter sized to snugly fit within the front collar 14 and an internal diameter sized to receive the PTO shaft 204 in a snug fit manner. The bearing 18 is positioned in the collar and abuts the stop 14a, with an internal through hole extending into the cavity 1b of the transfer case 1.

In the embodiment shown, the seal member 17 is a compression rubber washer. The seal member 17 is positioned within the front collar 14, before the retainer 16 and the bearing 18 and is sized to such that it compresses around the internal surface of the front collar 14, as well as the PTO shaft 204 when inserted into the first PTO shaft control assembly 12. The seal member 17 therefore seals the first PTO shaft control assembly 12, and prevents leakage from or into cavity 1b of the transfer case 1.

The retainer 16 is a fastener positioned in front of the bearing 18, and snug fit in the front collar 14 when assembled with the retainer receiving passageway 14b. Accordingly, when the first PTO shaft control assembly 12 is assembled, the bearing 18 is sung fit against the stop 14a.

In the embodiment shown, the retainer 16 is a ring that holds components or assemblies onto a shaft or in a housing/bore when installed in a groove. In the embodiment, shown the retainer 16 is received and secured by the retainer receiving passageway 14b. Self-locking retaining rings may be used if no retainer receiving passageway 14b is provided. The retainer 16 is made from metal, such as stainless steel or beryllium copper, and is installed once the bearing 18 is positioned in the front collar 14 fit and secured in the first PTO shaft receiving passageway 10. Next, the seal member 17 is positioned against the retainer 16 in the embodiment shown. However, it is also possible to have different positional configurations of the retainer 16, seal member 17, and bearing 18, as well as the number of components utilized for the first PTO shaft control assembly 12.

The retainer 16 secures the bearing 18 against the stop 14a, such that no further movement into the front collar 14 is possible. The seal member 17 is then snug fit in the front collar 14. Accordingly, the first PTO shaft control assembly 12 is secured and capable of sealing the transfer case 1 once the PTO shaft is positioned through the first PTO shaft receiving passageway 10. Furthermore, the first PTO shaft control assembly 12 provides support for the PTO shaft 204, with the bearing 18 restricting lateral movement and providing efficient rotation through restricted friction.

Now with reference FIGS. 1-6, the rear housing 3 is shown, and includes a rear connection piece 8, the rear main shaft receiving passageway 5, and the second PTO shaft receiving passageway 20 disposed along the outer wall of the rear housing 3.

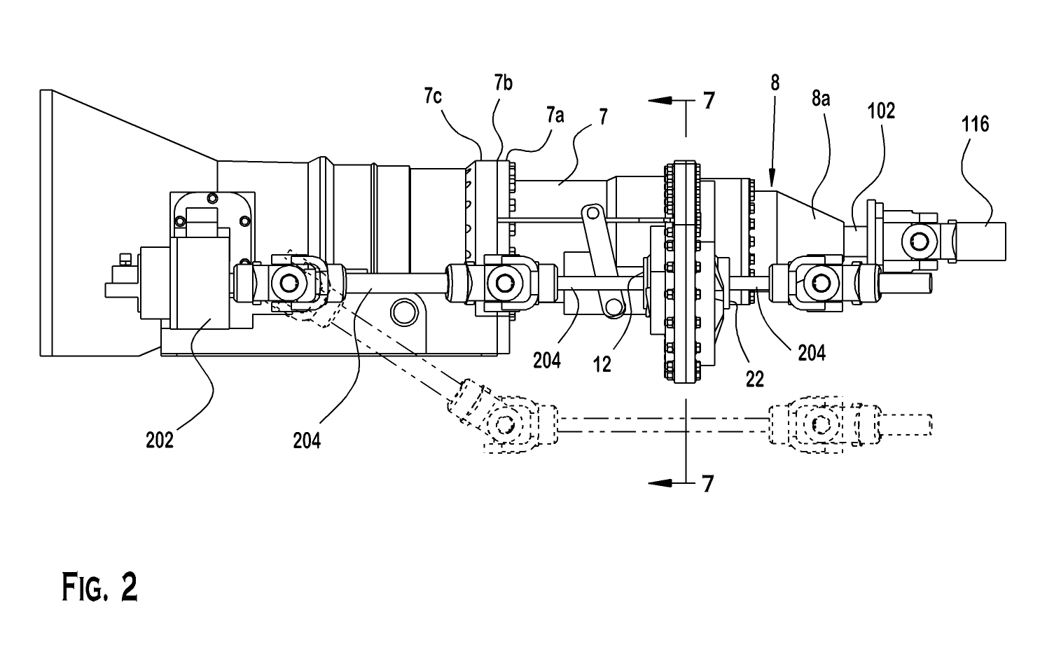

The rear connection piece 8 is positioned at one end of the rear housing 3. In the embodiment shown, the rear connection piece 8 includes an extension 8a (as shown in FIGS. 1 and 2). The main shaft 102 runs through the rear connection piece 8 and extension 8a and connects to rear drive shaft 116 using a universal joint or equivalent. The rear connection piece 8 connects to the extension using fasteners (i.e. nuts, bolts, or other known fasteners) and a seal (not shown) positioned there between. The rear connection piece 8 further includes a hollow cavity and is sized such that the main shaft 102 of the transfer case 1 extends there through and connects to the rear drive shaft 114. The extension 8 is also a hollow structure that narrows to a passageway through which the main shaft 102 extends through.

The rear main shaft receiving passageway 5 and the second PTO shaft receiving passageway 20 are positioned along and through an outer wall of the rear housing 3. Each of these through holes are used to receive one of two drive shafts and/or drive assemblies, and each through hole extends into the cavity 1b of the transfer case 1.

The rear main shaft receiving passageway 5 is positioned at an opposite end of rear connection piece 8 with respect to the extension 8a, through which the main shaft 102 extends and connects to the rear drive shaft 114. Since the rear connection piece 8 and the extension 8a are hollow, this structure allows for a passageway from extension into a cavity 1b of the transfer case 1 when the rear housing 3 is assembled with the front housing 2. The rear main shaft receiving passageway 5 should be sized to accommodate the main shaft 102 of the transfer case 1 extending through the transmission connection piece 7, the front main shaft receiving passageway 4, and then the cavity 1b of the transfer case. However, it is possible that the front main shaft receiving passageway 4, the rear main shaft receiving passageway 5, and cavity 1b of the transfer case can be sized to hold other components utilized in known transfer cases.

The second PTO shaft receiving passageway 20 is positioned to correspond with the first PTO shaft receiving passageway 10. The second PTO shaft receiving passageway 20 should be sized to accommodate the PTO shaft 204 and receive the second PTO shaft control assembly 22. In the embodiment shown, the second PTO shaft receiving passageway 20 is positioned closer to another end opposite the end on which the rear connection piece 8 and the rear main shaft receiving passageway 5 are positioned. Since the second PTO shaft receiving passageway 20 is positioned to correspond with the first PTO shaft receiving passageway 10, the PTO shaft 204 should not interfere with the front drive assembly 30, the front drive shaft 112, and other transfer case internal components, such as the drive chain 40.

As shown in FIG. 5, the second PTO shaft control assembly 22 includes the following components, a rear collar 24, a bearing 28, a seal member 27, and a retainer 26.

The rear collar 24 is a tubular element, and can either be cast with the rear housing 3 or a separate component that is secured to the rear housing 3 along the second PTO shaft receiving passageway 20. If the rear collar 24 is separate component, then the rear collar 24 is is positioned through the second PTO shaft receiving passageway 20 and secured to the outer wall of the rear housing 3 by a weld or other securing means known to the art. One end of the rear collar 24 (front end) extends through the second PTO shaft receiving passageway 20 and beyond the outer wall of the rear housing 3.

The rear collar 24 is hollow structure, having a tubular shaft, such that the rear collar 24 structure has measurements that include an internal diameter and an outer diameter. These diameters correspond to an inner collar surface and an outer collar surface of the rear collar 24, respectively. The internal diameter of the rear collar 24 is sized to accommodate components of the second PTO shaft control assembly 22 and the PTO shaft 204, while the outer diameter of the rear collar 24 is sized to snugly fit with the second PTO shaft receiving passageway 20, if the rear collar 24 is a separate component with respect to the rear housing 3. The rear collar 24 thickness is measured by a distance from the inner collar surface to the outer collar surface. The thickness is set so that the rear collar 24 supports the outer wall of the rear housing 3 around the second PTO shaft receiving passageway 20, such that the outer wall of the rear housing 3 is protected when the transfer case 1 according to the invention operates with a power take off shaft 204 positioned there through.

Further shown in FIG. 5, the rear collar 24 includes a stop 24a and a retainer receiving passageway 24b . The stop 24a is a wall positioned on another end of the rear collar 24 (rear end) and includes a through hole sized to accommodate the PTO shaft 204 there through. The retainer receiving passageway 24b is a set distance away from the stop 24a toward the secured end. The retainer receiving passageway 24b is disposed along the internal collar surface of the rear collar 24. In the embodiment shown, the retainer receiving passageway 24b is a channel extending from the internal collar surface into rear collar 24 and toward the outer collar surface. The depth and dimensions of the channel depends on the type of retainer 26 used for securing the bearing 28 and seal member 27 in the rear collar 24. Also, the distance between the stop 24a and the retainer receiving passageway 24b is dependent on dimensions of the bearing 28, which is positioned there between when the second PTO shaft control assembly 22 is assembled in the second PTO shaft receiving passageway 20. In the embodiment shown, the retainer receiving passageway 24b is positioned around the internal collar surface such that the retainer receiving passageway 24b is key fit with the retainer 26 when assembled together.

The bearing 28 is positioned between the fixed, non rotating rear collar 24 and the rotating power take off shaft 204, in which the rotating part (inner ring) and the stationary part (outer ring) are separated by a ring of rolling elements in order to reduce friction.

In the embodiment shown, the bearing 28 is a ball bearing type. It permits constrained relative motion between rear collar 24 and the PTO shaft 204, while also reducing friction. In other embodiments the bearing may be a cylindrical roller, needle, tapered roller, or spherical roller type of bearing. Furthermore, in other embodiments, the bearing 28 can be a plain bearing or a friction bearing having just a bearing surface and no rolling elements. The bearing 28 is sized to snugly fit within the rear collar 24 and to receive the PTO shaft 204. The bearing 28 is positioned in the rear collar 24 and abuts the stop 24a, with an internal through hole extending into the cavity 1b of the transfer case 1 for receiving the PTO shaft 204.

In the embodiment shown, the seal member 27 is a rubber compression washer. The seal member 27 is positioned before the retainer 26 and the bearing 28 within the rear collar 24. The seal member 27 is sized to compress around the internal surface of the rear collar 24, as and the PTO shaft 204. The seal member 27 therefore seals the second PTO shaft control assembly 22, and prevents leakage from or into cavity 1b of the transfer case 1

The retainer 26 is positioned in front of the bearing 28, and is snug fit in the rear collar 24 when assembled with the retainer receiving passageway 24b. Accordingly, the second PTO shaft control assembly 22 is assembled, the bearing 28 are sung fit against the stop 24a.

In the embodiment shown, the retainer 26 is a ring that holds components or assemblies onto a shaft or in a housing/bore when installed in a groove. The retainer 26 is received and secured by the retainer receiving passageway 24b. Alternatively, self-locking retaining rings may be used if no retainer receiving passageway 24b is provided. The retainer 26 is made from metal, such as stainless steel or beryllium copper. It is installed secured in the second PTO shaft receiving passageway 20 once the bearing is positioned in the rear collar 24. Then, the seal member 27 is positioned within the rear collar 24 against the retainer 26, thus sealing the second PTO shaft control assembly 22.

The seal member 27 engages the bearing 28 which abuts the stop 24a, to limit movement of the bearing 28 and the seal member 27 in the rear collar 24. The retainer 26 is then positioned to engage the retainer receiving passageway 24b in order to hold the seal member 27 and bearing 28 against the stop 24a and inhibit lateral movement of the second PTO shaft control assembly 22 within the second PTO shaft receiving passageway 20. Accordingly, the second PTO shaft control assembly 22 is secured and capable of sealing the transfer case 1 once the PTO shaft is positioned through the second PTO shaft receiving passageway 20. Furthermore, the second PTO shaft control assembly 22 provides support for the PTO shaft 204, with the bearing 28 restricting lateral movement and providing efficient rotation through restricted friction.

Now with reference to FIGS. 1 and 5, the front drive assembly 30 will be discussed in further detail. It includes the front drive assembly having a front drive shaft coupler 32, a front drive sprocket 34, and a bearing assembly 36.

The front drive shaft coupler 32 has a flanged coupler 32a and an elongated shaft 32b. In the embodiment shown, the flanged coupler 32a is a universal joint consisting of pair of hinges connected to one or more rods (i.e. elongated shaft 32b and front drive shaft 112) . One hinge is connected to the elongated shaft 32b and the other hinge is connected to the front drive shaft 112. Also, in the embodiment shown, the flanged coupler includes a circular plate positioned between one hinge and the elongated shaft 32b. The plate provides the front drive shaft coupler with a flange member positioned against the outer wall of the front housing 2 of the transfer case 1. Other connection and coupling members known in the art may be used to restrict motion of front drive shaft 112 with respect to the elongated shaft 32b.

The elongated shaft 32b is a rigid shaft connected to the flanged coupler 32a. The elongated shaft 32b is received by the front drive shaft receiving passageway 6 and abuts a recess positioned in the rear housing 3.

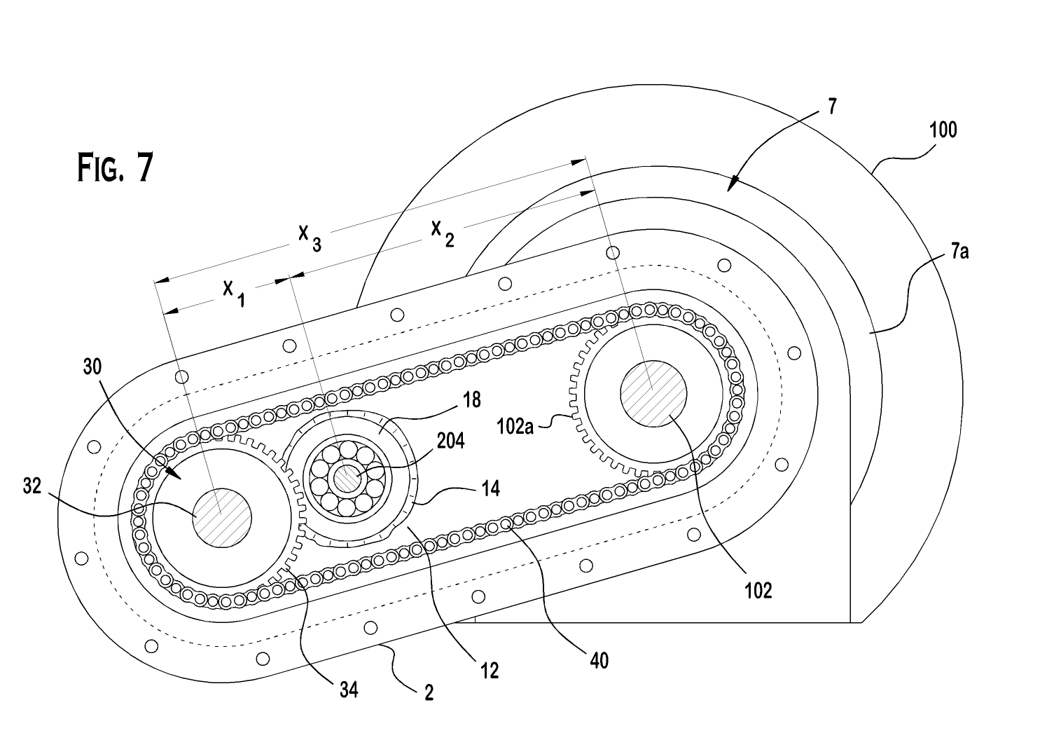

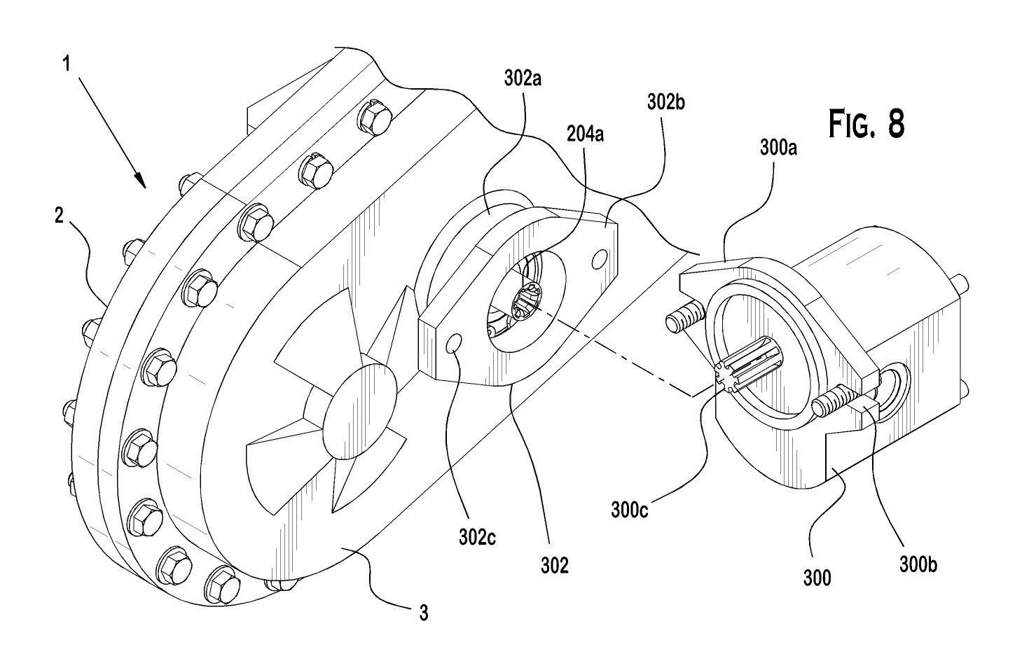

A front drive sprocket 34 is attached to the elongated shaft 32b. The front drive sprocket 34 is a profiled wheel with teeth capable of connecting with and engaging a chain, track or other perforated or indented material. In the embodiment shown, the front drive sprocket 34 rigidly connects to the elongated shaft 32b within the cavity 1b of the transfer case 1 (see also FIG. 7.

The bearing assembly 36 is also positioned within the cavity 1b of the transfer case and includes a pair of bearings. However, a first bearing is positioned in and snug fit in a first recess of the front housing 2 and a second bearing is positioned in and snug fit in a second recess disposed in rear housing 3. Both the first and second recess are positioned to correspond with each such that the elongated shaft may be receiving by both bearings. In the embodiment shown, the bearings used are similar to the ones described above for the first and second control assemblies 12 and 22. The first bearing is positioned on side of the front drive sprocket 34, while the second bearing is positioned on another side of the front drive sprocket 34. Each bearing has an external diameter sized to snugly fit within either of the first and second recesses and an internal diameter sized to receive the elongated shaft 32b of the front drive shaft coupler 32.

As shown in FIG. 7, the front drive assembly 30 is positioned a distance X₃ away from the transfer case main shaft 102, which is positioned at an opposite end of the transfer case 1 than the front drive assembly 30. The main shaft 102 is a known input shaft leading from the transmission back through the transfer case 1. The main shaft 102 includes an main shaft sprocket 102a that is profiled to engage a common drive chain 40 connected to the front drive sprocket 34. However, any continuous belt or gear system can be used instead of the shown drive chain 40 to drive the front drive assembly 30 by rotation of the main shaft 102.

As shown in FIGS. 1, 2 and 5, a power take off assembly 200 is disposed on a side of the transmission 100 and includes drive mechanism 202 and the PTO shaft 204. The PTO shaft 204 extends rearward and through the transfer case 1, connecting to a secondary implement generally positioned on a bracket in the rear of the vehicle.

The transfer case 1 according to the invention is designed such that the PTO shaft 204 does not interfere with the drive chain 40 when it passes through the first PTO shaft receiving passageway 10 and the second PTO shaft receiving passageway 20. In the embodiments shown, the first PTO shaft receiving passageway 10 is positioned between the main shaft 102 and the front drive shaft coupler 32. Furthermore, as described above, the first PTO shaft receiving passageway 10 corresponds with the second PTO shaft receiving passageway 20 (see FIG. 5) such that the PTO shaft 204 extends through the transfer case 1 without obstruction. In fact, the PTO shaft 204 is positioned at distance X₁ from the front drive assembly 30 than which is less than a distance X₂ from the main shaft 102, so that the PTO shaft 204 extends linearly from the drive mechanism 202 (see also FIG. 7).

The transfer case 1 according to the invention advantageously minimizes the number of universal joints required to route the PTO shaft 204 around obstructions, and maintain clearance under the transfer case 1. Furthermore, the transfer case 1 accoridng to the invention allows the PTO shaft 204 to maintain acceptable driveline angles.

Now with reference to FIG. 7, and the following details how the main shaft 102 provides power to the front drive assembly 30. When transmission rotates, the output shaft rotates the transfer case main shaft 102, which then rotates the main shaft sprocket 102a, which then rotates the drive chain 40 and the front drive sprocket 34. Since the front drive sprocket 34 is mechanically connected to the front drive shaft coupler 32, the front drive shaft 112 rotates as well. The bearing assembly 36 allows the elongated shaft 32b to rotate within the transfer case 1 with little resistance.

During assembly, in the embodiment shown, the first PTO shaft control assembly 12 and the first bearing are positioned in the first PTO shaft receiving passageway 10 and the first recess of the front housing 2, respectively. The second PTO shaft control assembly 22 and the second bearing are positioned in the second PTO shaft receiving passageway 20 and the second recess of the rear housing 3.

For the first PTO shaft control assembly 12, the front collar 14 is positioned in the first PTO shaft receiving passageway 10, and then secured to the outer walls of the front housing 2 by a weld. However, it is also possible that the front collar 14 is cast with the front housing 2. The bearing 18 is positioned inside the collar against the stop 14a and the retainer 16 is positioned against bearing 18. The seal member 17 is then positioned against the retainer 16 and snug fit in the front collar 14, while the retainer 16 is snug fit in the retainer receiving passageway 14b of the front collar 14. However, other variations are possible, including positioning and number of components.

For the second PTO shaft control assembly 22, the rear collar 24 is positioned in the second PTO shaft receiving passageway 20, and then secured to the outer walls of the rear housing 3 by a weld. However, it is also possible that the rear collar 24 is cast with the rear housing 3. The bearing 28 is positioned inside the rear collar 24 against the stop 24a and the retainer 26 is positioned against bearing 28. The seal member 27 is then positioned against the retainer 26 and snug fit in the rear collar 24, while the retainer 26 is snug fit in the retainer receiving passageway 24b of the rear collar 24. However, other variations are possible, including positioning and number of components.

The elongated shaft 32b of the front drive shaft coupler 32 is positioned through the front drive shaft receiving passageway 6 and the second bearing . The front drive sprocket 34 is positioned on and secure to the elongated shaft 32b, which is then positioned in the second bearing of the rear housing 3.

The transmission main shaft 102 is positioned through the front main shaft receiving passageway 4 and the main shaft sprocket 102a is rigidly attached to the main shaft sprocket 102a such that the main shaft sprocket 102a corresponds to the front drive sprocket 34. The drive chain 40 is positioned in the cavity 1b of the transfer case 1 and engaged with each front drive sprocket 34 and main shaft sprocket 102a.

A gasket is then positioned along the peripheral walls of the front housing 2 and the rear housing 3, which are then matched correspondingly together and secured by fasteners. The transmission main shaft 102 extends through the rear main shaft receiving passageway 5 and connects to the rear drive shaft 116 using universal joints or couplers.

Next, the PTO shaft 204 is positioned through the first PTO shaft receiving passageway 10, the first PTO shaft control assembly 12, the second PTO shaft control assembly 22, and the second PTO shaft receiving passageway 20. Since the seal members 17, 27 and the bearings 18, 28 of the first and second control assemblies 14, 22 are snug fit around the PTO shaft 204, the transfer case is sealed.

Now with reference to FIG. 8, a secondary implement assembly according to the invention is discussed. The secondary implement assembly includes a secondary implement 300 and a secondary implement coupler 302.

Generally, a secondary implement 300, such as hydraulic pump is generally positioned on a bracket in the a rear of a vehicle. However, it is advantageous to position the secondary implement 300 closer to the transfer case 1, in order increase ground clearance or utilize a piece of equipment positioned in the front of the vehicle.

As shown in FIG. 8, the secondary implement coupler 302 is disposed on and secured to the rear collar 24. The secondary implement coupler 302 is a tubular element 302a with a flanged plate 302b. The tubular element 302a is received by the rear collar 24 and flanged plate 302b rests against an outer wall of the rear collar 24. The flanged plate 302b attaches to the secondary implement 300 having a matching coupler system 300a designed to correspond with the structure of the secondary implement coupler 302. In the embodiment shown, the flanged plate 302b has a plurality of threaded fastener receiving recesses 302c. The matching coupler system 300a includes a plurality of fastener receiving passageways 300b that correspond with the threaded fastener receiving recesses 302c when the secondary implement coupler 302 and secondary implement 300 are matched and secured by fasteners that extend through the fastener receiving passageways 300b secured in the threaded fastener receiving recesses 302c.

The PTO shaft 204 includes a splined end section 204a positioned on an end of the PTO shaft 204. The splined end section 204a extends through the tubular element 302a and is connectable with the secondary implement coupler 302, which includes a receiving member 300c.

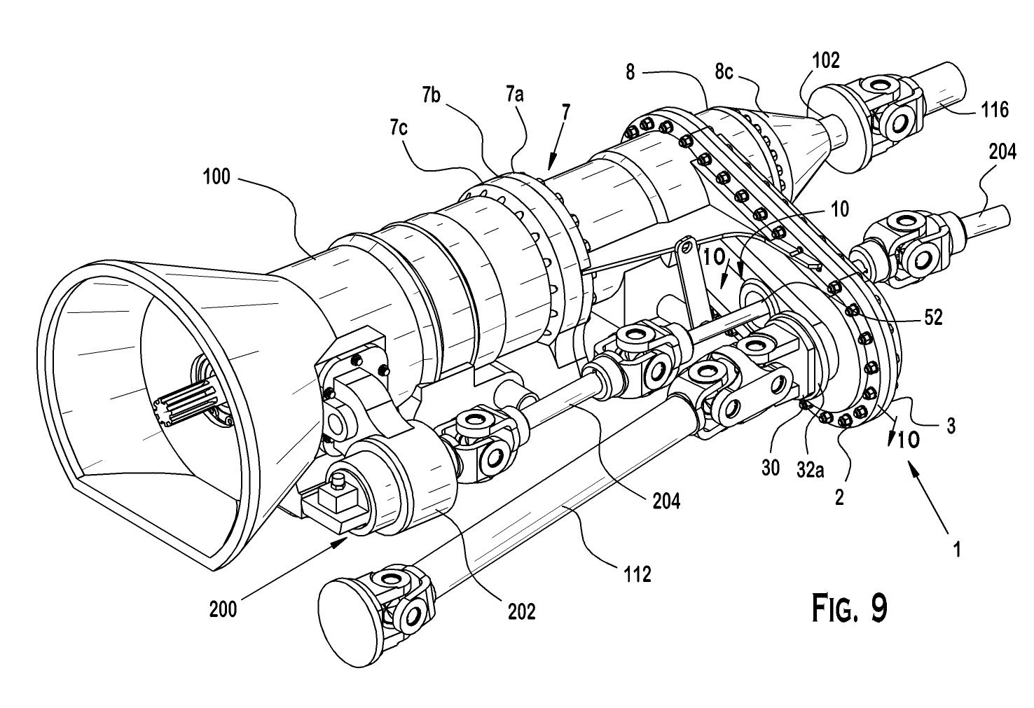

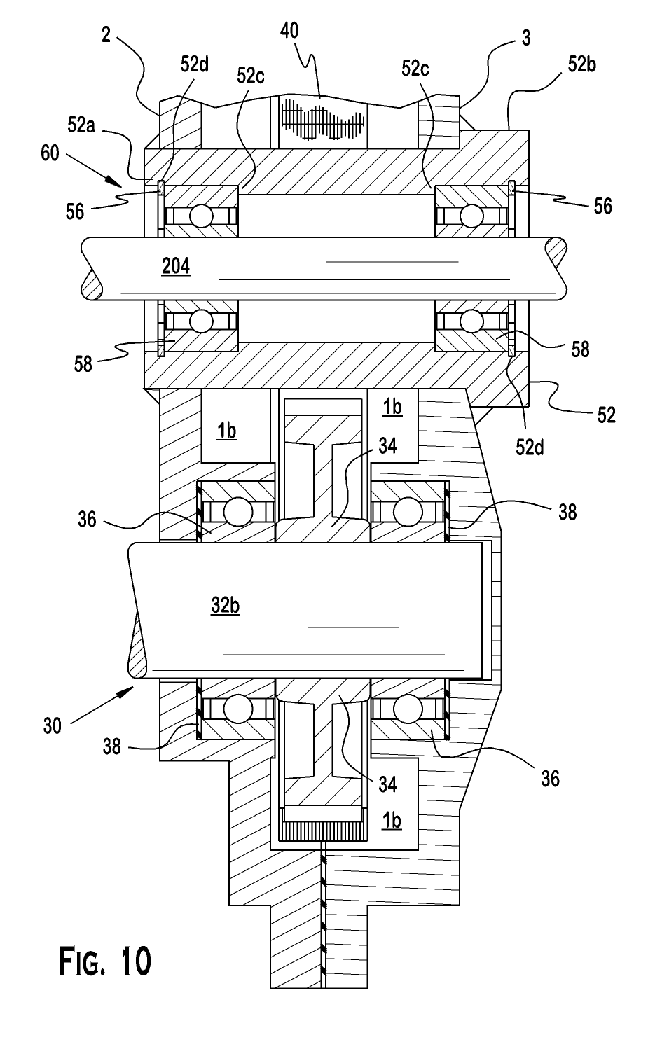

Now with reference to FIGS. 9 and 10, another embodiment of the transfer case 1 is shown. Like parts of the transfer case 1 are provided with like reference numerals and like component references throughout. Furthermore, features or feature combinations from the different embodiments shown and described may also represent inventive solutions or solutions included within the invention. For the sake of brevity, only the differences from the exemplary embodiments of FIGS. 1 and 9 will be described.

The transfer case 1 shown in FIGS. 9 and 10 includes a receiving tube 52 that includes a tubular section 52a and a flanged end section 52b. Instead of having the front collar 14 and the rear collar 24 positioned in the first PTO shaft receiving passageway 10 and the second PTO shaft receiving passageway 20 respectively, the receiving tube 52 is used. The receiving tube 52 has the same diameter dimensions and structure of the rear collar 24, except the receiving tube 52 is an elongated tubular element that extends from the second PTO shaft receiving passageway 20 through the cavity 1b and the first PTO shaft receiving passageway 10. The flanged end section 52b is a plate having a larger diameter than the second PTO shaft receiving passageway 20. In the embodiment shown, the flanged end section 52b rests against and is secured to the outer wall of the rear housing 3 by a weld. The tubular section 52a extends through the cavity and beyond the first PTO shaft receiving passageway 10. The end opposite the flanged end section 52b is secured to the outer walls of the front housing 2 by a weld. However, it is possible in other embodiments that the flanged end section 52a is positioned against the outer walls of the front housing 2 and the tubular section 52a extends through and beyond the second PTO shaft receiving passageway 20, secured to the rear housing 3 outer wall by a weld. However, it is possible that the receiving tube 52 is cast with the front or rear housings 2, 3, and the tube section 52a extend through the other, which is then secured by a weld or other known technique.

The flanged end section includes a bearing 58 and a retainer 56, without need for a seal member. The fit and design of the receiving shaft 52, the bearing 58 and retainer 56 are like that of the first and second control assemblies 12, 22, described above. For instance, the receiving shaft 52 includes a stop 52c and a retainer receiving passageway 52d, such that when the bearing 58 is positioned in the receiving shaft 52, the bearing 58 abuts the stop 52c and further movement into the receiving shaft 52. The retainer 56 is then positioned to engage with the retainer receiving passageway dispose din the receiving shaft 52 in order to hold the bearing 58 against the stop 52c and inhibit lateral movement of the first bearing 58 within the first PTO shaft receiving passageway 10. Accordingly, the bearing 58 is secured and the PTO shaft 204 is positioned through the receiving shaft 52 and the bearing 58. The type of bearing used is consistent with that which is described above with respect to the first and second control assemblies 12, 22.

In yet another embodiment, it is also possible to include a second bearing 60, positioned at an entrance of the receiving shaft 52.

The shape and configuration of the first and second control assemblies 12, 22, the front drive assembly 30, and the receiving shaft 52 are not limited to that which is shown. Other configurations are possible, such as type and position of the bearing assemblies and seal members used.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A transfer case for a power take off assembly comprising:
a front housing having:
(a) an main shaft receiving passageway positioned at one end of the front housing;
(b) a front drive shaft receiving passageway positioned at an opposite of the front housing with respect to the main shaft receiving passageway; and
(c) a first shaft receiving passageway being positioned between the main shaft receiving passageway and the front drive shaft receiving passageway and having a first shaft control assembly for receiving the PTO shaft; and
a rear housing having a second shaft receiving passageway with a second shaft control assembly positioned to correspond with the first shaft receiving passageway.

2. The transfer case according to claim 1, wherein the front housing attaches to the transmission.

3. The transfer case according to claim 1, wherein the first shaft receiving passageway is positioned closer to the front drive shaft receiving passageway than the main shaft receiving passageway to accommodate a substantially straight passage of the PTO shaft through the first shaft receiving passageway and through the secondary receiving passageway.

4. The transfer case according to claim 1, wherein the rear housing includes a rear main shaft receiving passageway positioned at one end of the rear housing and corresponds to the main shaft receiving passageway.

5. The transfer case according to claim 1, further comprising a seal positioned between the front housing and the rear housing and fasteners for securing the front housing to the rear housing.

6. The transfer case according to claim 1, wherein the first shaft control assembly is positioned in the first shaft receiving passageway and into a cavity.

7. The transfer case according to claim 6, wherein first shaft control assembly includes a front collar disposed on and secured to the front housing along a periphery of the first shaft receiving passageway.

8. The transfer case according to claim 7, wherein the first shaft control assembly includes a first bearing and a first retainer.

9. The transfer case according to claim 8, wherein the front collar includes a first stop having a recess and a wall on which the first bearing rests upon when the first bearing is positioned in the front collar.

10. The transfer case according to claim 9, wherein the front collar further includes a first retainer receiving passageway that receives the first retainer when the first bearing is positioned against the first stop in order to inhibit lateral movement of the first bearing within the first shaft receiving passageway.

11. The transfer case according to claim 10, wherein the second shaft control assembly includes rear collar, a second bearing and a second retainer.

12. The transfer case according to claim 11, wherein the rear collar includes a second stop having a recess and a wall on which the second bearing rest when the second bearing is positioned in the rear collar.

13. The transfer case according to claim 12, wherein the rear collar includes a second retainer receiving passageway that receives the second retainer when the second bearing is positioned against the second stop in order to inhibit lateral movement of the second bearing within the second shaft receiving passageway.

14. The transfer case according to claim 1, wherein further comprising a front drive assembly positioned in a cavity of the transfer case and extending through the front drive shaft receiving passageway.

15. The transfer case according to claim 14, wherein the front drive assembly includes a front drive shaft coupler connecting to a universal coupler, a front drive sprocket disposed n the front drive shaft coupler, and a bearing assembly positioned on both sides of the front drive sprocket.

16. The transfer case according to claim 15, wherein the front drive shaft coupler includes (1) a flanged coupler positioned outside the transfer case and connects to a front drive shaft through a connector, and (2) an elongated shaft that passes through the front drive shaft receiving passageway and sits in a recess of the rear housing.

17. The transfer case according to claim 16, wherein the front drive sprocket is attached to the elongated shaft.

18. The transfer case according to claim 1, further comprising a secondary implement coupler disposed on a rear collar of the second shaft control assembly.

19. The transfer case according to claim 18, wherein the secondary implement coupler includes a shaft that extends into the rear collar and a flanged plate that is secured to an outer wall of the rear collar.

20. The transfer case according to claim 19, wherein the shaft includes a receiving passageway for receiving a splined end section of the PTO shaft.

21. A transfer case for a transmission, the transfer case comprising:
a front housing having:
(a) a main shaft receiving passageway positioned on one end of the front housing;
(b) a front drive shaft receiving passageway positioned at another end of the front housing, opposite the input shaft receiving section; and
(c) a first shaft receiving passageway positioned between the main shaft receiving passageway and the front drive shaft receiving passageway;
a rear housing having a second shaft receiving passageway positioned to correspond with the first shaft receiving passageway; and
a receiving shaft inserted through and secured to the first and second shaft receiving passageways and having at least one control assembly.

22. The transfer case according to claim 21, wherein the receiving shaft includes a tubular element and a flanged end section.

23. The transfer case according to claim 22, wherein the flange end section rests on an outer wall of the rear housing and the shaft extends through the first shaft receiving passageway.

24. The transfer case according to claim 22, wherein the flange end section rests on an outer wall of the front housing and the shaft extends through the second shaft receiving passageway.

25. The transfer case according to claim 22, wherein the receiving shaft includes (1) a stop on which a bearing positioned in the receiving shaft rests and (2) a retainer receiving passageway for receiving a retainer that secures the bearing against the stop to inhibit lateral movement of the bearing.

26. The transfer case according to claim 24, further comprising a second bearing positioned at an end opposite of the flanged end section.
